(19) United States
(12) Patent Application Publication
(10) Pub. No.: US 2025/0365579 A1
(43) Pub. Date: Nov. 27, 2025

(54) VIRTUAL PRIVATE NETWORK WITH ISOLATED CONTROL AND DATA PLANES

(71) Applicant: NVIDIA Corporation, Santa Clara, CA (US)

(72) Inventors: Adam Geboff, Campbell, CA (US); Thorsten Peter Stremlau, Cary, NC (US)

(21) Appl. No.: 18/670,893

(22) Filed: May 22, 2024

(51) Int. Cl. H04W 12/088; H04W 12/037

(52) U.S. Cl. CPC H04W 12/088; H04W 12/037

(57) ABSTRACT

A system includes a controller device configured to perform control plane operations associated with a VPN and a primary VPN device in communication with the controller device and configured to perform data plane operations associated with the VPN. The data plane operations comprise initiating a request to establish a permanent secure communication channel with a remote VPN device. The control plane operations comprise generating and encrypting a temporary symmetric key with a private key of the controller device and a public key of the remote VPN device; transmitting, to a remote VPN endpoint device, the encrypted temporary symmetric key; receiving the temporary symmetric key encrypted with a public key of the primary VPN endpoint device; producing a permanent symmetric key by decrypting the temporary symmetric key encrypted with the public key of the primary VPN endpoint device; and establishing a permanent secure communication channel using the permanent symmetric key.

### TECHNICAL FIELD

At least one implementation pertains to establishing a virtual private network using an isolated control plane and an isolated data plane.

### BACKGROUND

A virtual private network (VPN) refers to techniques for establishing, over public networks, protected communication sessions between a remote client device and a protected network (e.g., an enterprise network). A client program (referred to as a VPN client) running on a client device (e.g., a laptop computer, a desktop computer, or other computing device) can establish one or more encrypted communication sessions with a VPN server, thus allowing the applications running on the client device to securely access computing resources which reside on the protected network.

### BRIEF DESCRIPTION OF DRAWINGS

Various implementations in accordance with aspects of the disclosure will be described with reference to the drawings, in which:

FIG. 1 is a schematic block diagram of an example system architecture for implementing a hardware-based VPN that employs two separate hardware devices to isolate the control plane from the data plane, in accordance with one or more aspects of the present disclosure.

FIG. 2 is a sequence diagram illustrating the establishment of a temporary secure communication channel between the controller device and the remote VPN device, in accordance with one or more aspects of the present disclosure.

FIG. 3 is a sequence diagram illustrating the establishment of a permanent secure communication channel between the primary VPN device and the remote VPN device, in accordance with one or more aspects of the present disclosure.

FIG. 4 is an example flow diagram of a method for establishment of a permanent secure communication channel between the primary VPN device and the remote VPN device, in accordance with one or more aspects of the present disclosure.

FIG. 5 is a block diagram illustrating an exemplary computer system which can be a system with interconnected devices and components, a system-on-a-chip (SOC), or some combination thereof, in accordance with one or more aspects of the present disclosure.

FIG. 6 is a block diagram illustrating an electronic device for utilizing a processor, in accordance with one or more aspects of the present disclosure.

FIG. 7 is a block diagram of a processing system, in accordance with one or more aspects of the present disclosure.

### DETAILED DESCRIPTION

To connect to a VPN server, a client device typically launches a VPN client to establish a secure session with the VPN server by authenticating the user of the client device and/or the client device itself (e.g., by presenting login credentials, such as a username password pair, to the VPN server). Once the VPN server authenticates the client, a secure encrypted session may be established between the client device and the VPN server.

Software-based VPNs employ software installed both on the server and the client device. A software VPN encrypts both client-originated messages and server-originated messages. However, these techniques for providing a VPN that relies solely on software implemented encryption can be vulnerable to certain types of cyberattacks (e.g., man-in-the middle attacks, replay attacks, unauthorized access, etc.).

Hardware-based VPNs employ physical devices that encrypt the server-originated messages and decrypt client-originated messages. However, a hardware-based VPN might not isolate the data plane from the control plane, which are logical channels defined by the type of information they respectively carry. In particular, the data plane is a logical channel of a VPN that carries user data while the control plane is a logical channel of a VPN defines the configuration information (e.g., network topology such as the physical and logical arrangement of nodes and connections in a network) and controls activities related to packet forwarding and traffic routing. In particular, the control plane determines how and to which ports or nodes the data packets should be forwarded, and the data plane forwards the packets. Implementing the functions of both planes using the same security measures may increase the attack surface, since only a single layer of security would need to be compromised to gain access to the data transmitted on the VPN.

Aspects and implementations of the present disclosure address the above-described and other deficiencies by implementing a hardware-based VPN employing separate logical channels employing independent security mechanisms, thus isolating the control plane activities from the data plane activities. In an illustrative example, a primary VPN endpoint device (referred to as a primary VPN device) and a secondary VPN device (referred to as a controller device) can be used to establish a secure VPN session between the primary VPN device and a remote VPN endpoint device (referred to as a remote VPN server). The primary VPN device can be employed to perform data plane operations, such as data encryption and transmission. The controller device can be used to handle control plane operations, including cryptography key management and authentication operations. Segregating the control plane and the data plane minimizes the attack surface of the VPN. The controller device can have a hardware root of trust for storing cryptographic data and performing security operations (e.g., performing an attestation of a device, generating respective public-private key pairs, generating a signed digital certificate, generating a symmetric key, etc.).

Upon initialization, both the primary VPN device and the controller device generate a respective set of asymmetric cryptographic key-pairs (e.g., public-private key pairs). The primary VPN device and the controller device then generate respective digital certificates that each include the respective device's public key along with the respective device's identification data. The controller device can then exchange certificates with the remote VPN server and establish a temporary secure communication channel using their respective public/private keys.

Responsive to the primary VPN device requesting, e.g., via a client program, the establishment of an encrypted communication session with the remote VPN server, the controller device can generate a temporary symmetric key that will be used for secure VPN communications. The controller device then twice encrypts the temporary symmetric key, first with its private key and the public key of the remote VPN server (or vice versa). The encrypted key is sent, by the controller device, to the remote VPN server via the temporary secure communication channel.

The remote VPN server decrypts the temporary symmetric key using its private key and the public key of the controller device. The temporary symmetric key is then used as a shared secret for establishing a permanent secure communication channel.

To complete the key exchange, the remote VPN server re-encrypts the temporary symmetric key with the controller device's public key and sends the encrypted temporary symmetric key to the controller device. The controller device then decrypts the received temporary symmetric key using its private key and compares the decrypted key with its copy of the temporary symmetric key. Should the two copies match, the controller device establishes a permanent secure communication channel with the remote VPN server using the temporary symmetric key (now a permanent symmetric key) as a shared secret. The controller device then sends the permanent symmetric key to the primary VPN device to use for communication with the remote VPN server. Accordingly, the operations of the controller device can be hidden from the primary VPN device, which only requests a permanent secure communication channel to a remote VPN server and receives the permanent symmetric key establish the permanent secure communication channel.

In certain implementations, the controller device can use these key exchange operations to establish respective permanent secure communication channels between multiple primary VPN devices and one or more remote VPN servers. This allows the controller device to operate as an enterprise VPN by, for example, establishing secure access for multiple users of an organization. In some implementations, an enterprise policy can be used to establish the secure access, where the enterprise policy is transparent to the software layers of the primary VPN device. The enterprise policy can enable secure access to be constantly maintained (e.g., all data is tunneled), creation of the permanent secure communication channel whenever a user tries to access certain destinations (e.g., URLs, domains, etc.), creation of the permanent secure communication channel only during certain hours, etc.

Advantages of the disclosure include, but are not limited to, a decrease in the attack surface of a hardware-based VPN since the control plane and the data plane are isolated from each other via different logical channels employing different security measures. Thus, two separate logical channels need to be compromised to gain access to the data transmitted on the VPN. Other advantages include enhanced security and reduced susceptibility to various types of cyber-attacks, such as man-in-the-middle attacks.

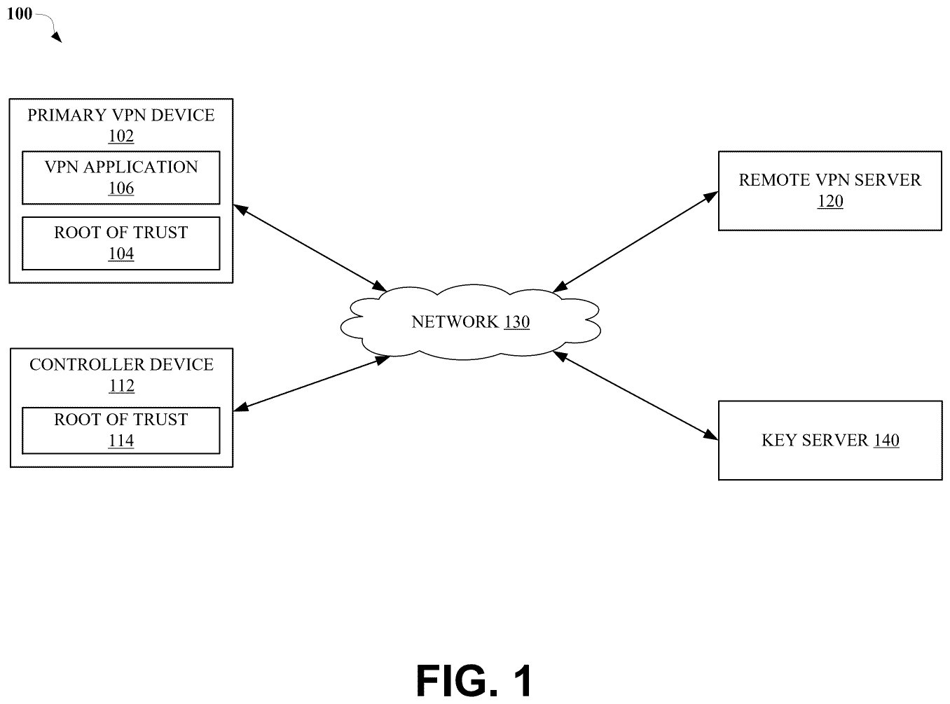

FIG. 1 is a schematic block diagram of an example system architecture 100 for implementing a hardware-based VPN that employs two different logical channels via separate hardware devices to isolate the control plane from the data plane, according to various implementations. The system architecture 100 includes primary VPN device 102, controller device 112, remote VPN server 120, and key server 140, each connected to network 130. Network 130 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In some implementations, the primary VPN device and the controller device can be a single hardware device (e.g., a hardware device with two hardware components).

Primary VPN device 102 can be a client device configured to perform data plane operations, such as, for example, encryption and user data transmission. Primary VPN device 102 can include one or more computing device such as a personal computer (PC), a laptop, a mobile phone, a smart phone, a tablet computer, a netbook computer, a network-connected television, etc. To transmit user data, primary VPN device 102 can use a client program such as VPN application 106. VPN application 106 can be a mobile application, a desktop application, a web browser, or any other software used to establish a secure VPN session between VPN application 106 and VPN device 120. In some implementations, VPN application 106 can present, on a display device of primary VPN device 102, a user interface (UI) for users to establish the secure VPN session. For example, a user can be presented with a UI element (e.g., a window, a button, etc.) to initiate a VPN session on primary VPN device 102. Responsive to a request to initiate the VPN session, controller device 112 can execute a set of key exchange operations (discussed in detail below) to establish an encrypted connection (e.g., a VPN tunnel) between primary VPN device 102 and remote VPN server 120. In some implementations, the UI element can include a window requesting a username and password (or other identification information) for authentication and/or initiation purposes.

Primary VPN device 102 can include a hardware root of trust 104 that stores cryptographic data and performs security and encryption operations. The security and encryption operations can include performing an attestation of a device (e.g., primary VPN device 102), generating cryptographic keys (e.g., public-private key pairs, a symmetric key, etc.), generating a signed digital certificate, encrypting data using a cryptographic key, etc. The hardware root of trust 104 can include a secure processor that performs cryptographic functions on behalf of the general-purpose processor of primary VPN device 102. Specifically, the general-purpose processor can be responsible for overall control of primary VPN device 102 while the secure processor operates on behalf of the general-purpose processor. The hardware root of trust 104 can further include a memory device (e.g., volatile memory, non-volatile memory, one-time-programmable memory, etc.), and security components configured to generate cryptographic keys, generate signed digital certificates, encrypt data (e.g., encrypt cryptographic keys, encrypt user data, etc.), decrypt data (e.g., decrypt cryptographic keys, decrypt user data, etc.), generate hash functions, generate nonce values (arbitrary values used just once in a cryptographic communication or operation), generate random numbers, store data (e.g., store cryptographic keys, store signed digital certificates, etc.), and so forth. In some implementations, any or all of the security and encryption operations can be performed outside of the hardware root of trust 104 (e.g., by a general-purpose processor of primary VPN device 102).

Controller device 112 can be configured to handle, for primary VPN device 102, control plane operations. In some implementations, controller device 104 can include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to perform the control plane operations.

Similar to primary VPN device 102, controller device 112 can include a hardware root of trust 114 that stores cryptographic data and performs security and encryption operations (e.g., performing an attestation of the controller device 112, generating cryptographic keys, generating a signed digital certificate, encrypting data using a cryptographic key, etc.). The hardware root of trust 114 can include a secure processor that performs cryptographic functions on behalf of the general-purpose processor of controller device 112. The hardware root of trust 114 can further include a memory device and security components configured to generate cryptographic keys, generate signed digital certificates, encrypt data, decrypt data, generate hash functions, generate nonce values, generate random numbers, store data, and so forth. In some implementations, any or all of the security and encryption operations can be performed outside of the hardware root of trust 114 (e.g., by a general-purpose processor of controller device 102).

Remote VPN server 120 can be one or more physical machines (e.g., server machines, desktop computers, etc.) that each include one or more processing devices communicatively coupled to memory devices and input/output (I/O) devices. The processing devices can include a computer, microprocessor, logic device or other device or processor that is configured with hardware, firmware, and software to carry out some of the implementations described herein. Remote VPN server 120 can be used to establish a secure communication channel (e.g., first a temporary secure communication channel, then a permanent secure communication channel) with primary VPN device 102. In particular, remote VPN server 120 can be the opposite end of a VPN tunnel from primary VPN device 102. In some implementations, remote VPN server 120 can include a hardware root of trust (not shown) for storing cryptographic data and performs security and encryption operations, similar to those operations described with respect to hardware roots of trust 104, 114. In some implementations, any or all of the security and encryption operations can be performed outside of the hardware root of trust of remote VPN server 120.

In some implementations, remote VPN server 120 can use key server 140 to store one or more cryptographic keys (or other cryptographic data, such as, for example, signed digital certificates), perform certain or all security and encryption operations on behalf of remote VPN server 120, etc. Remote VPN server 120 can be one or more physical machines (e.g., server machines, desktop computers, etc.) that each include one or more processing devices communicatively coupled to memory devices and input/output (I/O) devices. The processing devices can include a computer, microprocessor, logic device or other device or processor that is configured with hardware, firmware, and software to carry out some of the implementations described herein. In some implementations, key server 140 include a persistent storage that is capable of storing cryptographic keys (or other cryptographic data). Key server 140 can be hosted by one or more storage devices, such as main memory, magnetic or optical storage-based disks, tapes or hard drives, NAS, SAN, and so forth. In some implementations, data store 140 can be a network-attached file server, while in other implementations data store 140 can be some other type of persistent storage such as an object-oriented database, a relational database, and so forth, that can be hosted by a cloud-based environment or one or more different machines coupled to a cloud-based environment. In some implementations, key server 140 can include one or more hardware roots of trust to perform security and encryption operations. The hardware roots of trust and the security and encryption operations can be similar to those described above with reference to primary VPN device 102 and controller device 112.

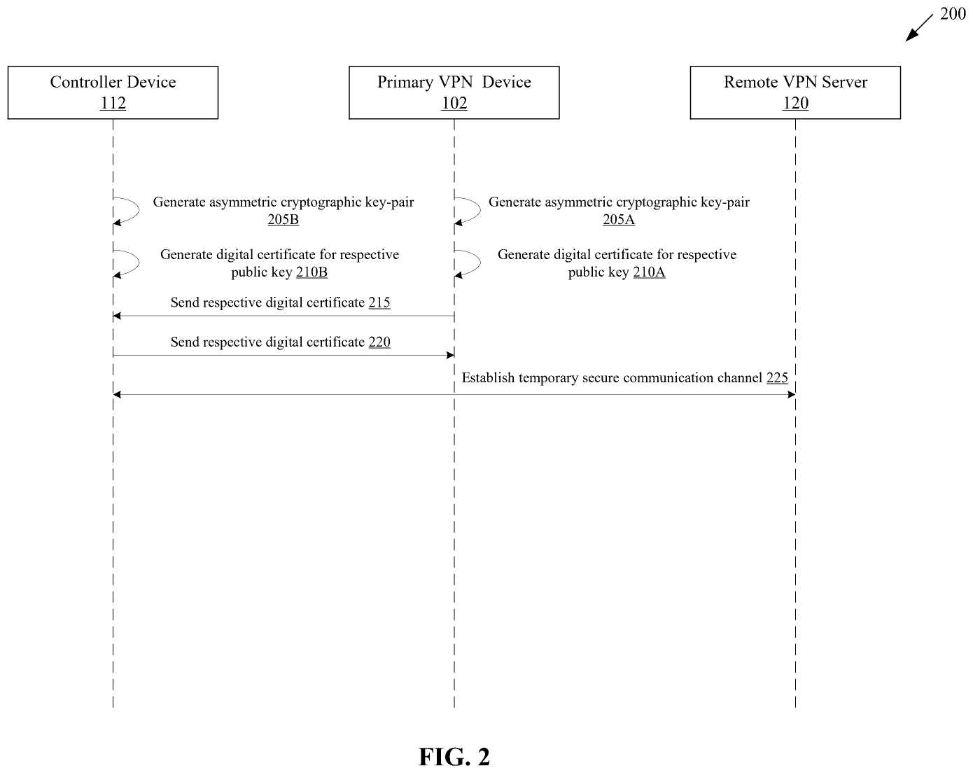

FIG. 2 is a sequence diagram illustrating the establishment of a temporary secure communication channel between the controller device and the remote VPN device, in accordance with some implementations of the disclosure. Diagram 200 can include similar elements as illustrated in computer system 100 as described with respect to FIG. 1. It can be noted that elements of FIG. 1 can be used herein to help describe FIG. 2. The operations described with respect to FIG. 2 are shown to be performed serially for the sake of illustration, rather than limitation. Although shown in a particular sequence or order, unless otherwise specified, the order of the operations can be modified. Thus, the illustrated implementations should be understood only as examples, and the illustrated operations can be performed in a different order, while some operations can be performed in parallel. Additionally, one or more operations can be omitted in some implementations. Thus, not all illustrated operations are required in every implementation, and other process flows are possible. In some implementations, the same, different, fewer, or greater operations can be performed. Diagram 200 illustrates primary VPN device 102, controller device 112, and remote VPN server 120.

In some implementations, some or all of the operations of method 200 can be performed during an initialization phase (e.g., a boot operation) of primary VPN device 102, controller device 112, and/or remote VPN server 120. For example, each or any of primary VPN device 102, controller device 112, or remote VPN server 120 can generate respective asymmetric cryptographic key-pairs and/or corresponding signed digital certificates during their respective boot operations. In some implementations, one or more operations of method 200 can be performed in response to certain criteria being satisfied (e.g., in response to user input, expiration of a timer, a certain operation being performed, etc.).

At operation 205A, primary VPN device 102 generates its asymmetric cryptographic key-pair. The key-pair (also referred to as the “primary VPN device key-pair”) can include a private key and a corresponding public key. In an example, primary VPN device 102 can perform a boot operation, a login operation, etc., which may involve generating the key-pair. To generate the key-pair, primary VPN device 102 (via, for example, hardware root of trust 104) can first perform an attestation operation to verify the integrity of primary VPN device 102. The attestation operation(s) can include, for example, validating the firmware of primary VPN device 102 by obtaining a measurement (e.g., obtaining one or more cryptographic representations for the primary VPN device 102 state) and comparing the measurement to a stored value (e.g., an expected value). The attestation operation can be performed using, for example, a trusted platform module (TPM), a device identifier composition engine (DICE), etc. Once the integrity is verified, primary VPN device 102 can generate its key-pair and store the key-pair in a secure environment (e.g., on hardware root of trust 104).

At operation 205B, controller device 112 generates its asymmetric cryptographic key-pair. The key-pair (also referred to as the “controller device key-pair”) can include a private key and a corresponding public key. Similar to the primary VPN device key-pair, to generate the controller device key-pair, controller device 112 (via, for example, hardware root of trust 114) can first perform an attestation operation(s) to verify the integrity of controller device 112. Once the integrity is verified, controller device 112 can generate its key-pair and store the key-pair in a secure environment (e.g., on hardware root of trust 114).

At operation 210A, the primary VPN device 102 generates a signed digital certificate for its public key. The signed digital certificate can include the public key of the primary VPN device key-pair along with the identification data of the primary VPN device 102.

At operation 210B, the controller device 112 generates a signed digital certificate for its public key. The signed digital certificate can include the public key of the controller device key-pair along with the identification data of the controller device 112.

At operations 215 and 220, primary VPN device 102 and controller device 112 exchange their respective signed digital certificates. In particular, at operation 215, primary VPN device 102 sends its signed digital certificate to controller device 112. At operation 220, controller device 112 sends its signed digital certificate to primary VPN device 102. Each of primary VPN device 102 and controller device 112 can verify the received signed digital certificates. To verify a signed digital certificate, the recipient device (e.g., VPN device 102, controller device 112, remoter VPN device 120, key server 140, etc.) can verify that the encrypted data on the signed digital certificate matches original data (e.g., using a trusted party), that the certificate is properly signed by a trusted source, that the certificate is received within its validity period, etc. In some implementations, certain or all communications between primary VPN device 102 and controller device 112 can encrypted by the sending device using the receiving device's public key, and decrypted by the receiving device using its private key. In some implementations, primary VPN device 102 can further send, to remote VPN device, a signed digital certificate containing the public key of controller device 112.

In some implementations, primary VPN device 102 and controller device 112 can communicate with each other using other means of encrypted or unencrypted communications. As such, in these implementations, primary VPN device 102 may not generate an asymmetric cryptographic key-pair nor send its digital certificate to controller device 112.

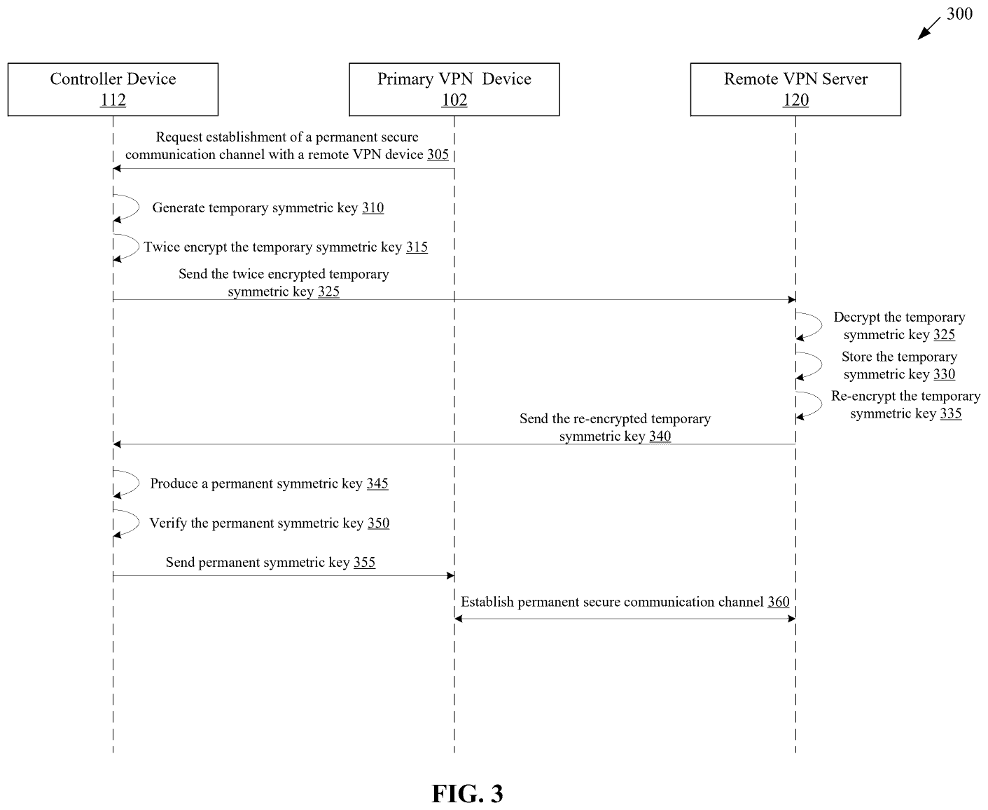

At operation 225, controller device 112 establishes a temporary secure communication channel to remote VPN server 120. The temporary secure communication channel can be established by exchanging the public keys (e.g., via the respective signed digital certificates) of controller device 112 and remote VPN server 120. In particular, controller device 112 sends its signed digital certificate to remote VPN server 120 and remote VPN server 120 sends its signed digital certificate to controller device 112. The receiving devices can then verify each respective received signed digital certificate. In some implementations, remote VPN server 120 can obtain its signed digital certificate from a key server (e.g., key server 140). In some implementations, remote VPN server 120 can store the signed digital certificate obtained from controller device 112 (and/or the public key from the certificate) on key server 140. The key exchange can be performed using one or more key exchange protocols, such as, for example, Internet Key Exchange (IKE) protocol (versioned as IKEv1 and IKEv2). Once the temporary secure communication channel is established, the operations of diagram 300 of FIG. 3, below, can be used to establish a permanent secure communication channel between the primary VPN device 102 and the remote VPN server 120.

FIG. 3 is a sequence diagram illustrating the establishment of a permanent secure communication channel between the primary VPN device and the remote VPN device, in accordance with some implementations of the disclosure. Diagram 300 can include similar elements as illustrated in computer system 100 as described with respect to FIG. 1. Elements of FIG. 1 can be used herein to help describe FIG. 3. The operations described with respect to FIG. 3 are shown to be performed serially for the sake of illustration, rather than limitation. Although shown in a particular sequence or order, unless otherwise specified, the order of the operations can be modified. Thus, the illustrated implementations should be understood only as examples, and the illustrated operations can be performed in a different order, while some operations can be performed in parallel. Additionally, one or more operations can be omitted in some implementations. Thus, not all illustrated operations are required in every implementation, and other process flows are possible. In some implementations, the same, different, fewer, or greater operations can be performed. Diagram 300 illustrates primary VPN device 102, controller device 112, and remote VPN server 120.

At operation 305, the primary VPN device 102 requests the establishment a permanent secure communication channel with a remote VPN device. For example, VPN application 106 can receive user input requesting the initiation of a VPN session primary VPN device 102.

At operation 310, controller device 112 generates a temporary key. Implementations of diagram 300 will be discussed with reference to the temporary key being a symmetric key (e.g., a key that is used to encrypt and decrypt data). However, other types of cryptographic keys can be used as a temporary key (e.g., asymmetric keys, hash functions, encryption algorithms, etc.). In some implementations, the temporary symmetric key can be generated using hardware root of trust 112. In some implementations, controller device 112 can perform an attestation operation(s) to verify the integrity of controller device 112 prior to generating the temporary symmetric key.

At operation 315, controller device 112 twice encrypts the temporary symmetric key. In some implementations, the controller device 112 can encrypt the temporary symmetric key using its private key (e.g., the private key of the controller device 112) and the public key of the remote VPN server 120. In some implementations, the twice encrypted temporary symmetric key can then be cryptographically signed (e.g., a signed digital certificate can be generated for the twice encrypted temporary symmetric key) by controller device 112.

At operation 320, controller device 112 sends the twice encrypted temporary symmetric key to remote VPN server 120 via the temporary secure communication channel. For example, controller device 112 can send the signed digital certificate related to the twice encrypted temporary symmetric key.

At operation 325, remote VPN server 120 verifies the signed digital certificate and decrypts the twice encrypted temporary symmetric key. To decrypt the twice encrypted temporary symmetric key, remote VPN server 120 (or key server 140) can first decrypt the temporary symmetric key using the private key of the remote VPN server 120 and then the public key of the controller device 112, or vice versa.

At operation 330, remote VPN server 120 stores the decrypted temporary symmetric key. In some implementations, the decrypted temporary symmetric key is stored on remote VPN server 120. In some implementations, the decrypted temporary symmetric key is stored on key server 140.

At operation 335, remote VPN server 120 re-encrypts the temporary symmetric key. In some implementations, the remote VPN server 120 can re-encrypt the temporary symmetric key using one or more of its private key (e.g., the private key of the remote VPN server 120) and/or the public key of the controller device 112. In some implementations, the re-encrypted temporary symmetric key can then be cryptographically signed (e.g., a signed digital certificate can be generated for the re-encrypted temporary symmetric key) by remote VPN server 120.

At operation 340, remote VPN server 120 sends the re-encrypted temporary symmetric key to controller device 112.

At operation 345, controller device 112 produces a permanent symmetric key. To produce the permanent symmetric key, controller device 112 verifies the signed digital certificate and decrypts the re-encrypted temporary symmetric key. If the re-encrypted temporary symmetric key is twice encrypted, controller device 112 can first decrypt the temporary symmetric key using the public key of the remote VPN server 120 and then using its private key (e.g., the private key of the controller device 112), or vice versa. If the re-encrypted temporary symmetric key is once encrypted, controller device 112 can decrypt the temporary symmetric key using either the public key of the remote VPN server 120 or using its private key.

At operation 350, controller device 112 verifies the permanent symmetric key. To verify the permanent symmetric key, controller device 112 can determine whether the permanent symmetric key matches the instance of the temporary symmetric key previously stored by controller device 112. Responsive to determining that the permanent symmetric key matches the temporary symmetric key, controller device 112 can determine that the permanent symmetric key can be used for secure communication between primary VPN device 102 and remote VPN server 120. Responsive to determining that the permanent symmetric key failed to match the temporary symmetric key, controller device 112 can terminate communication with remote VPN server 120.

At operation 355, controller device 112 sends the permanent symmetric key to primary VPN device 102. In some implementations, the permanent symmetric key can be encrypted, by controller device 112, using the public key of primary VPN device 102. Once received, primary VPN device 102 can decrypt the permanent symmetric key using its private key and store the permanent symmetric key.

At operation 360, primary VPN device 102 establishes a permanent secure communication channel using the permanent symmetric key. In particular, the permanent symmetric key is used as a shared secret for establishing the permanent secure communication channel. Accordingly, data sent by primary VPN device 102 to remote VPN server 120 (or vice versa) can be encrypted, using permanent symmetric key, by the sending device and then decrypted, using the permanent symmetric key, by the receiving device.

In some implementations, the re-encrypted temporary symmetric key can be thrice encrypted (e.g., using the private key of the remote VPN server 120, the public key of the primary VPN device 102, and the public key of controller device 112). In such implementations, controller device 112 can use one or more of its private key and the public key of remote VPN server 120 to remove one or two layers of encryption, then send the still encrypted temporary symmetric key to primary VPN device 102 to remove the remaining layers of encryption using one or more of its private key and the public key of remote VPN server 120. It should be understood that other combinations of encryptions and decrypting can be used.

In some implementations, controller device 112 can perform automated key rotation operations. In particular, at periodic intervals (e.g., at the expiration of a time), controller device 112 can generate a new temporary symmetric key and establish a new permanent secure communication channel using a new permanent symmetric key. The new permanent symmetric key can be produced using one or more operations 310-360 of diagram 300. In such implementations, controller device 112 can instruct primary VPN device 102 to discard the current permanent symmetric key and continue communication with remote VPN server using the new permanent symmetric key.

In some implementations, controller device 112 can log key exchange data (e.g., time and date of generated keys, key exchange procedures, etc.) and authentication event data (e.g., encryption events, decryption events, attestations events, etc.). This data can be used for during potential audits and to ensure compliance with security standards (e.g., General Data Protection Regulation (GDPR), Health Insurance Portability and Accountability Act (HIPPA), etc.). Logging the key exchange data and authentication event data on controller device 112 prevents a data breach in the event that primary VPN device 102 is compromised.

In some implementations, controller device 112 can use the operations of diagram 200 and/or 300 to establish respective permanent secure communication channels between multiple primary VPN devices and one or more remote VPN servers. This allows controller device 112 to operate as an enterprise VPN by, for example, establishing secure access for multiple users of an organization.

In some implementations, an enterprise policy can be used to establish the secure access for one or more user, where the enterprise policy is transparent to the software layers of the primary VPN device. The enterprise policy can enable secure access to be constantly maintained (e.g., all data is tunneled), creation of the permanent secure communication channel whenever a user tries to access certain destinations (e.g., URLs, domains, etc.), creation of the permanent secure communication channel only during certain hours, etc.

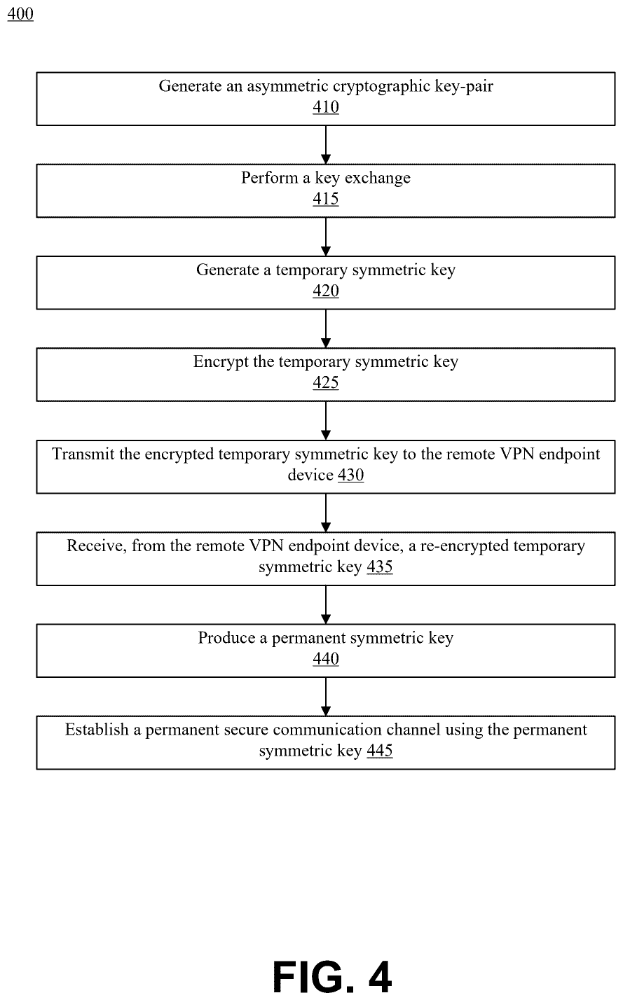

FIG. 4 is a flow chart of an example method 400 for establishment of a permanent secure communication channel between the primary VPN device and the remote VPN device, according to some implementations. The method 400 can be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In an example, method 400 can be performed by controller device 112 of FIG. 1.

Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 410, processing logic generates an asymmetric cryptographic key-pair. The key-pair can be generated during a boot operation and stored on a hardware root of trust. The processing logic can further generate a signed digital certificate for the public key of the key-pair.

At operation 415, processing logic performs a key exchange. The key-exchange can include exchanging public keys (or signed digital certificates that include respective public keys) with one or more primary VPN devices (e.g., primary VPN device 102) and with one or more remote VPN devices (e.g., remote VPN server 120). The key exchange can be used to establish a temporary secure communication channel with the controller device 112.

At operation 420, processing logic generates a temporary symmetric key. In some implementations, the temporary symmetric key can be generated in response to a request to establish a permanent secure communication channel for a remote VPN device.

At operation 425, processing logic encrypts the temporary symmetric key. For example, the temporary symmetric key can be encrypted using a public key of a remote VPN device key-pair and using a private key of the controller device key-pair.

At operation 430, processing logic transmits the encrypted temporary symmetric key to the remote VPN device. The twice encrypted temporary symmetric key can be send to the remote VPN device via the temporary secure communication channel.

At operation 435, processing logic receives, from the remote VPN device, a re-encrypted temporary symmetric key. The re-encrypted temporary symmetric key can be encrypted with the public key of the controller device and/or with the private key of the remote VPN device.

At operation 440, processing logic produces a permanent symmetric key. In some implementations, the permanent symmetric key is produced by decrypting the temporary symmetric key. The temporary symmetric key can be decrypted using one or more of the private key of the controller device and/or the public key of the remote VPN device. The processing logic can then validate the permanent symmetric key by determining whether the decrypted (candidate) symmetric key matches a stored temporary symmetric key.

At operation 445, processing logic establishes a permanent secure communication channel using the permanent symmetric key by sending the permanent symmetric key to the primary VPN device.

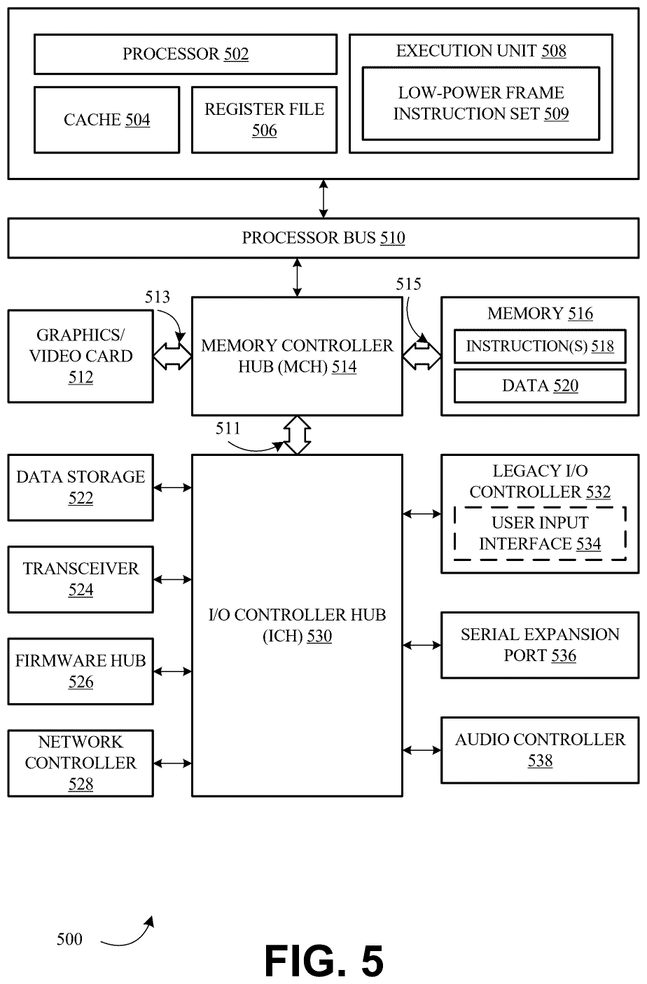

FIG. 5 is a block diagram illustrating an exemplary computer system, such as computer system 500, which can be a system with interconnected devices and components, a system-on-a-chip (SOC), or some combination thereof, according to aspects of the disclosure. In some implementations, computer system 500 can include, without limitation, a component, such as a processor 502, to employ execution units including logic to perform algorithms for process data, in accordance with the present disclosure, such as in the implementations described herein. In some implementations, computer system 500 can include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) can also be used. In some implementations, computer system 500 can execute a version of WINDOWS' operating system available from Microsoft Corporation of Redmond, Wash., although other operating systems (UNIX and Linux, for example), embedded software, and/or graphical user interfaces, can also be used.

Implementations can be used in other devices such as handheld devices and embedded applications. Some examples of handheld devices include cellular phones, Internet Protocol devices, digital cameras, personal digital assistants (PDAs), and handheld PCs. In some implementations, embedded applications can include a microcontroller, a digital signal processor (DSP), a system on a chip, network computers (NetPCs), set-top boxes, network hubs, wide area network (WAN) switches, or any other system that can perform one or more instructions in accordance with at least one implementation.

In some implementations, computer system 500 can include, without limitation, processor 502 that can include, without limitation, one or more execution units 508 to perform operations according to techniques described herein. In some implementations, computer system 500 is a single-processor desktop or server system, but in another implementation, the computer system 500 can be a multiprocessor system. In some implementations, processor 502 can include, without limitation, a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In some implementations, processor 502 can be coupled to a processor bus 510 that can transmit data signals between processor 502 and other components in computer system 500.

In some implementations, processor 502 can include, without limitation, a Level-1 (L1) internal cache memory (cache) cache 504. In some implementations, processor 502 can have a single internal cache or multiple levels of internal cache. In some implementations, the cache memory can reside external to processor 502. Other implementations can also include a combination of both internal and external caches depending on particular implementation and needs. In some implementations, register file 506 can store different types of data in various registers, including and without limitation, integer registers, floating-point registers, status registers, and instruction pointer registers.

In some implementations, an execution unit 508, including and without limitation, logic to perform integer and floating-point operations, also reside in processor 502. In some implementations, processor 502 can also include a microcode (μcode) read-only memory (ROM) that stores microcode for certain macro instructions. In some implementations, execution unit 508 can include logic to handle a low-power frame instruction set 509. In some implementations, by including low-power frame instruction set 509 in an instruction set of a general-purpose processor, such as processor 502, along with associated circuitry to execute instructions, operations used by many multimedia applications can be performed using packed data in a general-purpose processor, such as processor 502. In one or more implementations, many multimedia applications can be accelerated and executed more efficiently by using the full width of a processor's data bus for performing operations on packed data, which can eliminate the need to transfer smaller units of data across the processor's data bus to perform one or more operations one data element at a time.

In some implementations, execution unit 508 can also be used in microcontrollers, embedded processors, graphics devices, DSPs, and other types of logic circuits. In some implementations, computer system 500 can include, without limitation, a memory 516. In some implementations, memory 516 can be implemented as a Dynamic Random Access Memory (DRAM) device, a Static Random Access Memory (SRAM) device, a flash memory device, or other memory devices. In some implementations, memory 516 can store instruction(s) 518 and/or data 520 represented by data signals that can be executed by processor 502.

In some implementations, the system logic chip can be coupled to processor bus 510 and memory 516. In some implementations, the system logic chip can include, without limitation, a memory controller hub (MCH), such as MCH 514, and processor 502 can communicate with MCH 514 via processor bus 510. In some implementations, MCH 514 can provide a high bandwidth memory path 515 to memory 516 for instruction and data storage and for storage of graphics commands, data, and textures. In some implementations, MCH 514 can direct data signals between processor 502, memory 516, and other components in computer system 500 and bridge data signals between processor bus 510, memory 516, and a system input/output (I/O) 511. In some implementations, a system logic chip can provide a graphics port for coupling to a graphics controller. In some implementations, MCH 514 can be coupled to memory 516 through a high bandwidth memory path 515, and graphics/video card 512 can be coupled to MCH 514 through an Accelerated Graphics Port (AGP) interconnect 513.

In some implementations, computer system 500 can use the system I/O 511 that is a proprietary hub interface bus to couple the MCH 514 to I/O controller hub (ICH), such as ICH 530. In some implementations, ICH 530 can provide direct connections to some I/O devices via a local I/O bus. In some implementations, a local I/O bus can include, without limitation, a high-speed I/O bus for connecting peripherals to memory 516, chipset, and processor 502. Examples can include, without limitation, data storage 522, a transceiver 524, a firmware hub (flash Basic Input/Output System (BIOS)) 526, a network controller 528, a legacy I/O controller 532 containing a user input interface 534, a serial expansion port 536, such as Universal Serial Bus (USB), and an audio controller 538. In some implementations, data storage 522 can include a hard disk drive, a floppy disk drive, a compact disc read-only memory (CD-ROM) device, a flash memory device, or other mass storage devices.

In some implementations, FIG. 5 illustrates a computer system 500, which includes interconnected hardware devices or “chips,” whereas, in other implementations, FIG. 5 can illustrate an exemplary System on a Chip (SoC). In some implementations, devices can be interconnected with proprietary interconnects, standardized interconnects (e.g., Peripheral Component Interconnect buses (e.g., PCI, PCI Express)), or some combination thereof. In some implementations, one or more components of computer system 500 are interconnected using compute express link (CXL) interconnects.

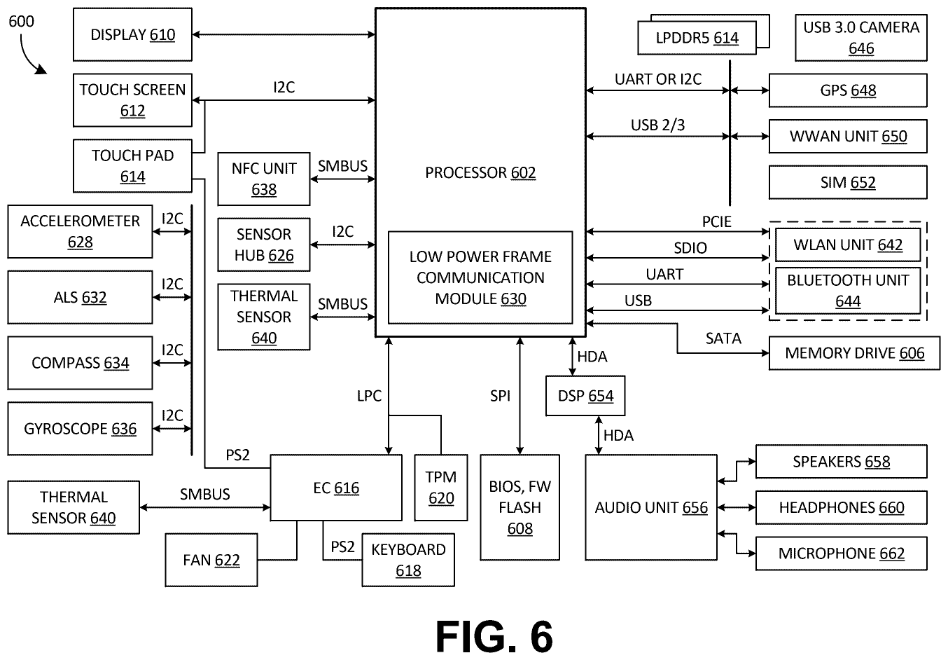

FIG. 6 is a block diagram illustrating an electronic device 600 for utilizing a processor 602, according to aspects of the disclosure. In some implementations, electronic device 600 can be, for example, and without limitation, a notebook, a tower server, a rack server, a blade server, a laptop, a desktop, a tablet, a mobile device, a phone, an embedded computer, or any other suitable electronic device.

In some implementations, electronic device 600 can include, without limitation, processor 602 communicatively coupled to any suitable number or kind of components, peripherals, modules, or devices. In some implementations, processor 602 coupled using a bus or interface, such as an Inter-Integrated Circuit (I2C) bus, a System Management Bus (SMBus), a Low Pin Count (LPC) bus, a Serial Peripheral Interface (SPI), a High Definition Audio (HDA) bus, a Serial Advance Technology Attachment (SATA) bus, a Universal Serial Bus (USB) (including USB 1.0/1/1, USB 2.0, USB 3.0/3.1 Gen1/3.1 Gen2, and USB4), or a Universal Asynchronous Receiver/Transmitter (UART) bus. In some implementations, FIG. 6 illustrates a system, which includes interconnected hardware devices or “chips,” whereas in other implementations, FIG. 6 can illustrate an exemplary System on a Chip (SoC). In some implementations, devices illustrated in FIG. 6 can be interconnected with proprietary interconnects, standardized interconnects (e.g., PCIe), or some combination thereof. In some implementations, one or more components of FIG. 6 are interconnected using compute express link (CXL) interconnects.

In some implementations, FIG. 6 can include a display 610, a touch screen 612, a touch pad 614, a Near Field Communications unit (NFC) 638, a sensor hub 626, a thermal sensor 640, an Express Chipset (EC), such as EC 616, a Trusted Platform Module (TPM), such as TPM 620, BIOS/firmware (FW)/flash memory, such as BIOS, FW Flash 608, a DSP 654, a memory drive 606 such as a Solid State Disk (SSD) or a Hard Disk Drive (HDD), a wireless local area network unit (WLAN), such as WLAN unit 642, a Bluetooth unit 644, a Wireless Wide Area Network unit (WWAN), such as WWAN unit 650, a Global Positioning System (GPS) 648, a camera (USB 3.0 camera) 646, such as a USB 3.0 camera, and/or a Low Network bandwidth Double Data Rate (LPDDR) memory unit, such as LPDDR5 604 implemented in, for example, LPDDR5 standard. These components can each be implemented in any suitable manner.

In some implementations, other components can be communicatively coupled to processor 602 through the components discussed above. In some implementations, processor 602 can include a low-power frame transmission module 630. In some implementations, an accelerometer 628, Ambient Light Sensor (ALS), such as ALS 632, compass 634, and a gyroscope 636 can be communicatively coupled to sensor hub 626. In some implementations, thermal sensor 640, a fan 622, a keyboard 618, and a touch pad 614 can be communicatively coupled to EC 616. In some implementations, speakers 658, headphones 660, and microphone 662 can be communicatively coupled to an audio unit 656 which can, in turn, be communicatively coupled to DSP 654. In some implementations, audio unit 656 can include, for example, and without limitation, an audio coder/decoder (codec) and a class-D amplifier. In some implementations, a subscriber identification module (SIM) card, such as SIM 652 can be communicatively coupled to WWAN unit 650. In some implementations, components such as WLAN unit 642 and Bluetooth unit 644, as well as WWAN unit 650 can be implemented in a Next Generation Form Factor (NGFF).

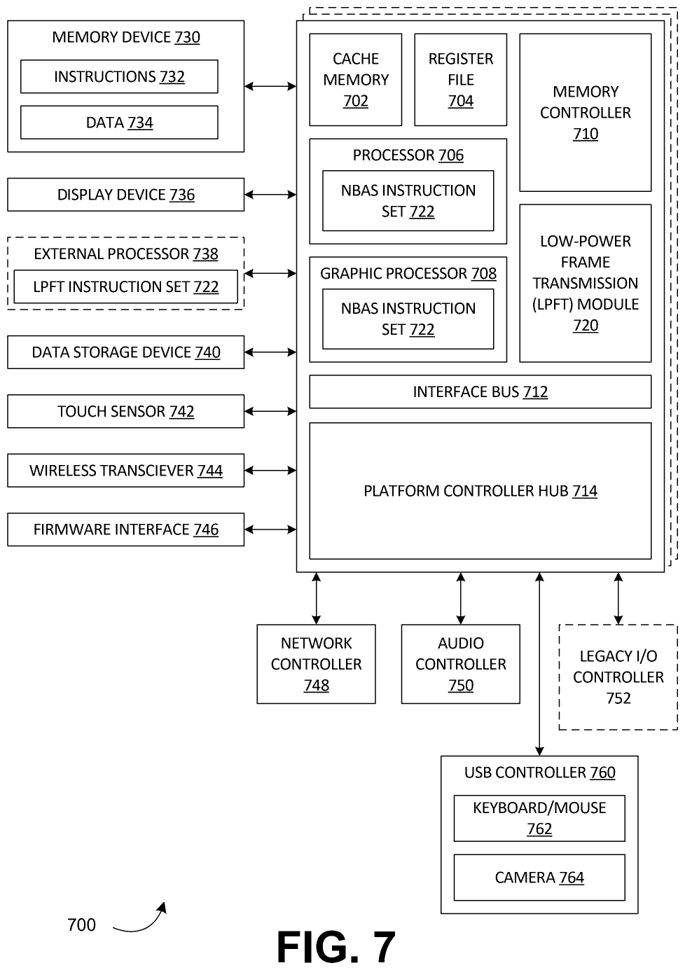

FIG. 7 is a block diagram of a processing system 700, according to aspects of the disclosure. In some implementations, the processing system 700 includes cache memory 702, register file 704, processors 706, graphics processors 708, memory controller 710, interface bus 712, platform controller hub 714, and low-power frame transmission module 720. Processing system 700 can be a single processor desktop system, a multiprocessor workstation system, or a server system having a large number of processors 706 or graphics processors 708. In some implementations, the processing system 700 is a processing platform incorporated within a system-on-a-chip (SoC) integrated circuit for use in mobile, handheld, or embedded devices.

In some implementations, the processing system 700 can include, or be incorporated within a server-based gaming platform, a game console, including a game and media console, a mobile gaming console, a handheld game console, or an online game console. In some implementations, the processing system 700 is a mobile phone, smart phone, tablet computing device, or mobile Internet device. In some implementations, the processing system 700 can also include, couple with, or be integrated within, a wearable device, such as a smart watch wearable device, smart eyewear device, augmented reality device, or virtual reality device. In some implementations, the processing system 700 is a television or set-top box device having one or more processors 706 and a graphical interface generated by one or more graphics processors 708.

In some implementations, one or more processors 706 each include one or more of the processor cores to process instructions which, when executed, perform operations for system and user software. In some implementations, one or more processors 706 and/or one or more graphics processors can be configured to process a portion of the low-power frame transmission (LPFT) instruction set, such as LPFT instruction set 722. In some implementations, LPFT instruction set 722 can facilitate Complex Instruction Set Computing (CISC), Reduced Instruction Set Computing (RISC), or computing via a Very Long Instruction Word (VLIW). In some implementations, processor cores can each process a different instruction set from LPFT instruction set 722, which can include instructions to facilitate emulation of other instruction sets (not illustrated). In some implementations, processor cores can also include other processing devices, such as a Digital Signal Processor (DSP).

In some implementations, processors 706 includes cache memory 702. In some implementations, processors 706 can have a single internal cache or multiple levels of internal cache. In some implementations, cache memory 702 is shared among various components of processors 706. In some implementations, processors 706 also uses an external cache (e.g., a Level-3 (L3) cache or Last Level Cache (LLC)) (not illustrated), which can be shared among processor cores using known cache coherency techniques. In some implementations, register file 704 is additionally included in processors 706, which can include different types of registers for storing different types of data (e.g., integer registers, floating-point registers, status registers, and an instruction pointer register). In some implementations, register file 704 can include general-purpose registers or other registers.

In some implementations, one or more processors 706 are coupled with one or more interface bus 712 to transmit communication signals such as address, data, or control signals between processor cores and other components in processing system 700. In some implementations, interface bus 712, in one implementation, can be a processor bus, such as a version of a Direct Media Interface (DMI) bus. In some implementations, interface bus 712 is not limited to a DMI bus, and can include one or more PCI buses (e.g., PCI, PCI Express), memory busses, or other types of interface busses. In some implementations, processors 706 include an integrated memory controller (e.g., memory controller 710) and a platform controller hub 714 (PCH). In some implementations, memory controller 710 facilitates communication between a memory device and other components of the processing system 700, while platform controller hub 714 provides connections to I/O devices via a local I/O bus.

In some implementations, the memory device 730 can be a dynamic random-access memory (DRAM) device, a static random-access memory (SRAM) device, a flash memory device, a phase-change memory device, or some other memory device having suitable performance to serve as process memory. In some implementations, the memory device 730 can operate as system memory for processing system 700 to store instructions 732 and data 734 for use when one or more processors 706 executes an application or process. In some implementations, memory controller 710 also optionally couples with an external processor 738, which can communicate with one or more graphics processors 708 in processors 706 to perform graphics and media operations. In some implementations, a display device 736 can connect to processors 706. In some implementations, the display device 736 can include one or more of an internal display device, as in a mobile electronic device or a laptop device, or an external display device attached via a display interface (e.g., DisplayPort, etc.). In some implementations, display device 736 can include a head-mounted display (HMD) such as a stereoscopic display device for use in virtual reality (VR) applications or augmented reality (AR) applications.

In some implementations, the platform controller hub 714 enables peripherals to connect to memory device 730 and processors 706 via a high-speed I/O bus. In some implementations, I/O peripherals include, but are not limited to, a data storage device 740 (e.g., hard disk drive, flash memory, etc.), a touch sensor 742, a wireless transceiver 744, firmware interface 746, a network controller 748, or an audio controller 750.

In some implementations, the data storage device 740 can connect via a storage interface (e.g., SATA) or via a peripheral bus, such as a PCI bus (e.g., PCI, PCI Express). In some implementations, touch sensor 742 can include touch screen sensors, pressure sensors, or fingerprint sensors. In some implementations, wireless transceiver 744 can be a Wi-Fi transceiver, a Bluetooth transceiver, or a mobile network transceiver such as a 3G, 4G, Long Term Evolution (LTE), 5G, or 6G transceiver. In some implementations, firmware interface 746 enables communication with system firmware and can be, for example, a unified extensible firmware interface (UEFI). In some implementations, the network controller 748 can enable a network connection to a wired network. In some implementations, a high-performance network controller (not illustrated) couples with interface bus 712. In some implementations, audio controller 750 can be a multi-channel high-definition audio controller. In some implementations, the processing system 700 includes an optional legacy I/O controller 752 for coupling legacy (e.g., Personal System-2 (PS/2)) devices to the processing system 700. In some implementations, the platform controller hub 714 can also connect to one or more Universal Serial Bus (USB) controllers, such as USB controller 760 to connect input devices, such as a keyboard and mouse combination (keyboard/mouse 762), a camera 764, or other USB input devices.

In some implementations, an instance of memory controller 710 and platform controller hub 714 can be integrated into a discreet external graphics processor, such as external processor 738. In some implementations, the platform controller hub 714 and/or memory controller 710 can be external to one or more processors 706. For example, in some implementations, the processing system 700 can include an external memory controller (e.g., memory controller 710) and the platform controller hub 714, which can be configured as a memory controller hub and peripheral controller hub within a system chipset that is in communication with the processors 706.

Other variations are within the spirit of the present disclosure. Thus, while disclosed techniques are susceptible to various modifications and alternative constructions, certain illustrated implementations thereof are shown in drawings and have been described above in detail. It should be understood, however, that there is no intention to limit the disclosure to a specific form or forms disclosed, on the contrary, the intention is to cover all modifications, alternative constructions, and equivalents falling within the spirit and scope of the disclosure, as defined in appended claims.

Use of terms “a” and “an” and “the” and similar referents in the context of describing disclosed implementations (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set can be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., can be either A or B or C, or any nonempty subset of a set of A and B and C. For instance, in an illustrative example of a set having three members, conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain implementations require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some implementations, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some implementations, code is stored on a computer-readable storage medium, for example, in form of a computer program comprising a plurality of instructions executable by one or more processors. In some implementations, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some implementations, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in some implementations, comprises multiple non-transitory computer-readable storage media and one or more of individual non-transitory storage media of multiple non-transitory computer-readable storage media lacks all of the code while multiple non-transitory computer-readable storage media collectively store all of the code. In some implementations, executable instructions are executed such that different instructions are executed by different processors, for example, a non-transitory computer-readable storage medium stores instructions, and a main central processing unit (CPU) executes some of the instructions while a graphics processing unit (GPU) executes other instructions. In some implementations, different components of a computer system have separate processors, and different processors execute different subsets of instructions.

Accordingly, in some implementations, computer systems are configured to implement one or more services that singly or collectively perform operations of processes described herein, and such computer systems are configured with applicable hardware and/or software that enable the performance of operations. Further, a computer system that implements at least one implementation of present disclosure is a single device and, in another implementation, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate implementations of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, can be used. It should be understood that these terms cannot be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other but yet still co-operate or interact with each other.

Unless specifically stated otherwise, it can be appreciated that throughout specification terms such as “processing,” “computing,” “calculating,” “determining,” or like, refer to action and/or processes of a computer or computing system or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. As non-limiting examples, a “processor” can be a CPU or a GPU. A “computing platform” can comprise one or more processors. As used herein, “software” processes can include, for example, software and/or hardware entities that perform work over time, such as tasks, threads, and intelligent agents. Also, each process can refer to multiple processes for carrying out instructions in sequence or in parallel, continuously, or intermittently. The terms “system” and “method” are used herein interchangeably insofar as a system can embody one or more methods, and methods can be considered a system.

In the present document, references can be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References can also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or an interprocess communication mechanism.

Although the discussion above sets forth example implementations of described techniques, other architectures can be used to implement described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
a primary virtual private network (VPN) device configured to perform data plane operations associated with a VPN, the data plane operations comprising:
initiating a request to establish a permanent secure communication channel with a remote VPN device; and
a controller device in communication with a primary VPN device and configured to perform control plane operations associated with the VPN, the control plane operations comprising:
in response to generating a temporary symmetric key, encrypting the temporary symmetric key with a private key of the controller device and a public key of the remote VPN device;
transmitting, via a temporary secure communication channel, the encrypted temporary symmetric key to the remote VPN device;
receiving, from the remote VPN device, the temporary symmetric key encrypted with a public key of the controller device;
producing a permanent symmetric key by decrypting, using the private key of the controller device, the temporary symmetric key encrypted with the public key of the controller device; and
establishing a permanent secure communication channel using the permanent symmetric key by sending the permanent symmetric key to the primary VPN device.

2. The system of claim 1, wherein producing the permanent symmetric key further comprises:
validating the permanent symmetric key by determining whether a candidate symmetric key matches the temporary symmetric key.

3. The system of claim 1, wherein the controller device comprises a hardware root of trust configured to:
perform attestation operations to validate the integrity of the controller device; and
generate the temporary symmetric key in response the attestation operations validating the integrity of the controller device.

4. The system of claim 1, wherein the controller device is configured to initiate, at periodic intervals, a set of operations to establish a new permanent secure communication channel using a new permanent symmetric key.

5. The system of claim 1, wherein the remote VPN device utilizes a key server to decrypt the temporary symmetric key using the public key of the controller device and a private key of the remote VPN device.

6. The system of claim 1, wherein the remote VPN device utilizes a key server to encrypt the temporary symmetric key using the public key of the controller device.

7. The system of claim 1, wherein the data plane operations further comprise:
establishing a further permanent secure communication channel, for another primary VPN device, using a different permanent symmetric key.

8. A method, comprising:
in response to generating, via a controller device in communication with a primary virtual private network (VPN) device and configured to perform control plane operations associated with a VPN, a temporary symmetric key, encrypting the temporary symmetric key with a private key of the controller device and a public key of the remote VPN device;
transmitting, via a temporary secure communication channel, the encrypted temporary symmetric key to the remote VPN device;
receiving, from the remote VPN device, the temporary symmetric key encrypted with a public key of the controller device;
producing a permanent symmetric key by decrypting, using the private key of the controller device, the temporary symmetric key encrypted with the public key of the controller device; and
establishing a permanent secure communication channel using the permanent symmetric key by sending the permanent symmetric key to the primary VPN device.

9. The method of claim 8, wherein producing the permanent symmetric key further comprises:
validating the permanent symmetric key by determining whether a candidate symmetric key matches the temporary symmetric key.

10. The method of claim 8, further comprising:
performing, via a hardware root of trust of the controller device, attestation operations to validate the integrity of the controller device; and
generating the temporary symmetric key in response the attestation operations validating the integrity of the controller device.

11. The method of claim 8, further comprising:
initiating, at periodic intervals via the controller device, a set of operations to establish a new permanent secure communication channel using a new permanent symmetric key.

12. The method of claim 8, further comprising:
utilizing, via the remote VPN device, a key server to at least one of decrypt the temporary symmetric key using the public key of the controller device and a private key of the remote VPN device.

13. The method of claim 8, further comprising:
utilizing, via the remote VPN device, a key server to encrypt the temporary symmetric key using the public key of the controller device.

14. The method of claim 8, further comprising:
establishing a further permanent secure communication channel, for another primary VPN device, using a different permanent symmetric key.

15. A non-transitory computer-readable storage medium comprising instructions that, when executed by a processing device operatively coupled to a memory, performs operations comprising:
in response to generating, via a controller device in communication with a primary virtual private network (VPN) device and configured to perform control plane operations associated with a VPN, a temporary symmetric key, encrypting the temporary symmetric key with a private key of the controller device and a public key of the remote VPN device;
transmitting, via a temporary secure communication channel, the encrypted temporary symmetric key to the remote VPN device;
receiving, from the remote VPN device, the temporary symmetric key encrypted with a public key of the controller device;
producing a permanent symmetric key by decrypting, using the private key of the controller device, the temporary symmetric key encrypted with the public key of the controller device; and
establishing a permanent secure communication channel using the permanent symmetric key by sending the permanent symmetric key to the primary VPN device.

16. The non-transitory computer-readable storage medium of claim 15, wherein the operations further comprise:
producing the permanent symmetric key by further validating the permanent symmetric key by determining whether a candidate symmetric key matches the temporary symmetric key.

17. The non-transitory computer-readable storage medium of claim 15, wherein the operations further comprise:
performing attestation operations to validate the integrity of the controller device; and
generating the temporary symmetric key in response the attestation operations validating the integrity of the controller device.

18. The non-transitory computer-readable storage medium of claim 15, wherein the operations further comprise:
initiating, at periodic intervals via the controller device, a set of operations to establish a new permanent secure communication channel using a new permanent symmetric key.

19. The non-transitory computer-readable storage medium of claim 15, wherein the operations further comprise:
utilizing, via the remote VPN device, a key server to at least one of decrypt the temporary symmetric key using the public key of the controller device and a private key of the remote VPN device.

20. The non-transitory computer-readable storage medium of claim 15, wherein the operations further comprise:
utilizing, via the remote VPN device, a key server to encrypt the temporary symmetric key using the public key of the controller device.
